(19) United States
(12) Patent Application Publication
(10) Pub. No.: US 2024/0320899 A1
(43) Pub. Date: Sep. 26, 2024

(54) METHOD AND APPARATUS FOR RENDERING SCENE PICTURE, DEVICE, STORAGE MEDIUM, AND PROGRAM PRODUCT

(71) Applicant: TENCENTTECHNOLOGY(SHENZHEN)COMPANYLIMITED, Shenzhen (CN)

(72) Inventors: Hailong WANG, Shenzhen (CN); Kai DING, Shenzhen (CN)

(73) Assignee: TENCENT TECHNOLOGY (SHENZHEN) COMPANY LIMITED, Shenzhen (CN)

(21) Appl. No.: 18/679,909

(22) Filed: May 31, 2024

Related U.S. Application Data
(63) Continuation of application No. PCT/CN2023/119402, filed on Sep. 18, 2023.

(30) Foreign Application Priority Data
Sep. 30, 2022 (CN) 202211210072.X

(51) Int. Cl. G06T 15/20; G06T 15/40

(52) U.S. Cl. CPC G06T 15/20; G06T 15/40

(57) ABSTRACT

A method, apparatus, and a non-transitory computer-readable medium storing program code may be provided. The method may include obtaining a first scene space unit in which a dynamic scene element in a scene space is located at a first moment and obtaining a first photographing space unit in which a virtual camera is located in a photographing space at the first moment. The method may also include determining a visibility relationship between the first scene space unit and the first photographing space unit based on prestored visibility data. When the visibility relationship between the first scene space unit and the first photographing space unit is invisible, the method includes removing the dynamic scene element and obtaining remaining dynamic scene elements in the scene space. The method then renders the scene picture in the first moment.

### CROSS-REFERENCES TO RELATED APPLICATIONS

This application is a continuation of International Application No. PCT/CN2023/119402, filed on Sep. 18, 2023, with the China National Intellectual Property Administration, which claims priority to Chinese Application No. 202211210072.X, filed on Sep. 30, 2022, with the China National Intellectual Property Administration, the disclosures of which are incorporated in their entireties by reference.

### FIELD

Embodiments of the present disclosure relate to the field of computer and rendering technologies, and in particular, to a method and apparatus for rendering a scene picture, a device, a storage medium, and a program product.

### BACKGROUND

In a scene space of a game, some scene elements are not visible at some angles of view because they are blocked by other scene elements.

In the related art, when a game is running, whether scene elements in a scene space are visible at a current angle of view is calculated in real time, and then a scene space is rendered based on real-time calculation results, to obtain a scene picture.

In the related art, because the visibility of the scene elements needs to be calculated in real time, the rendering efficiency of the scene picture is relatively low.

### SUMMARY

Embodiments of the present disclosure provide a method and an apparatus for rendering a scene picture, a device, a storage medium, and a program product, which can improve the rendering efficiency of the scene picture.

An embodiment of the present disclosure is directed to a method for rendering a scene with dynamic object elimination. The method may include obtaining a first scene space unit in which a dynamic scene element in a scene space is located at a first moment, wherein a first number of scene space units form the scene space; obtaining a first photographing space unit in which a virtual camera is located in a photographing space at the first moment, wherein the first photographing space unit, wherein a second number of photographing space units form the photographing space; determining a visibility relationship between the first scene space unit and the first photographing space unit based on prestored visibility data, wherein the prestored visibility data comprises visibility relationships between the first number of the scene space units and the second number of the photographing space units; when the visibility relationship between the first scene space unit and the first photographing space unit is invisible, removing the dynamic scene element from scene elements comprised in the scene space and obtaining remaining dynamic scene elements in the scene space; and rendering a scene picture in the first moment by rendering content within an angle of view of a first virtual camera in the scene space based on the remaining dynamic scene elements in the scene space.

An embodiment of the present disclosure is directed to an apparatus for rendering a scene with dynamic object elimination. The apparatus may include at least one memory configured to store program code; and at least one processor configured to read the program code and operate as instructed by the program code. The program code may include first obtaining code configured to cause the at least one first processor to obtain a first scene space unit in which a dynamic scene element in a scene space is located at a first moment, wherein a first number of scene space units form the scene space; second obtaining code configured to cause the at least one first processor to obtain a first photographing space unit in which a virtual camera is located in a photographing space at the first moment, wherein the first photographing space unit, wherein a second number of photographing space units form the photographing space; first determining code configured to cause the at least one first processor to determine a visibility relationship between the first scene space unit and the first photographing space unit based on prestored visibility data, wherein the prestored visibility data comprises visibility relationships between the first number of the scene space units and the second number of the photographing space units; first removing code configured to cause the at least one first processor to, when the visibility relationship between the first scene space unit and the first photographing space unit is invisible, remove the dynamic scene element from scene elements comprised in the scene space and obtaining remaining dynamic scene elements in the scene space; and first rendering code configured to cause the at least one first processor to render a scene picture in the first moment by rendering content within an angle of view of a first virtual camera in the scene space based on the remaining dynamic scene elements in the scene space.

An embodiment of the present disclosure is directed to a non-transitory computer-readable medium storing program code. The program code may, when executed by one or more processors of a device for rendering a scene with dynamic object elimination, cause the one or more processors to at least obtain a first scene space unit in which a dynamic scene element in a scene space is located at a first moment, wherein a first number of scene space units form the scene space; obtain a first photographing space unit in which a virtual camera is located in a photographing space at the first moment, wherein the first photographing space unit, wherein a second number of photographing space units form the photographing space; determine a visibility relationship between the first scene space unit and the first photographing space unit based on prestored visibility data, wherein the prestored visibility data comprises visibility relationships between the first number of the scene space units and the second number of the photographing space units; when the visibility relationship between the first scene space unit and the first photographing space unit is invisible, remove the dynamic scene element from scene elements comprised in the scene space and obtaining remaining dynamic scene elements in the scene space; and render a scene picture in the first moment by rendering content within an angle of view of a first virtual camera in the scene space based on the remaining dynamic scene elements in the scene space.

### BRIEF DESCRIPTION OF THE DRAWINGS

FIG. 1 is a flowchart of a method for rendering a scene picture according to an embodiment of the present disclosure.

FIG. 2 is a schematic diagram of a system for rendering a scene picture according to an embodiment of the present disclosure.

FIG. 3 is a flowchart of a method for rendering a scene picture according to another embodiment of the present disclosure.

FIG. 4 is a flowchart of a method for rendering a scene picture according to still another embodiment of the present disclosure.

FIG. 5 is a flowchart of a method for rendering a scene picture according to yet another embodiment of the present disclosure.

FIG. 6 is a schematic diagram of a space unit according to an embodiment of the present disclosure.

FIG. 7 is a schematic diagram of a space unit according to another embodiment of the present disclosure.

FIG. 8 is a schematic diagram of a space unit according to still another embodiment of the present disclosure.

FIG. 9 is a schematic diagram of a data fragment before clustering of a binary sequence set according to an embodiment of the present disclosure.

FIG. 10 is a schematic diagram of a data fragment after clustering of a binary sequence set according to another embodiment of the present disclosure.

FIG. 11 is a flowchart of a method for rendering a scene picture according to another embodiment of the present disclosure.

FIG. 12 is a block diagram of an apparatus for rendering a scene picture according to an embodiment of the present disclosure.

FIG. 13 is a block diagram of an apparatus for rendering a scene picture according to another embodiment of the present disclosure.

FIG. 14 is a block diagram of a terminal device according to an embodiment of the present disclosure.

### DETAILED DESCRIPTION

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with the present disclosure. On the contrary, the implementations are merely examples of methods that are described in detail in the appended claims and that are consistent with some aspects of the present disclosure.

The present disclosure relates to improving rendering scenes when there are occluded objects in a scene.

By prestoring a visibility relationship between a scene space unit and a photographing space unit in a form of visibility data, in an actual rendering process of a scene picture, after determining a scene space unit in which a scene space element is located and a photographing space unit in which a virtual camera is located, a visibility relationship between the scene space element and the virtual camera can be determined and a scene picture can be rendered by querying the visibility data. Therefore, the visibility of a scene element does not need to be calculated in real time, and the efficiency of determining the visibility of the scene element is improved, thereby further improving the rendering efficiency of the scene picture.

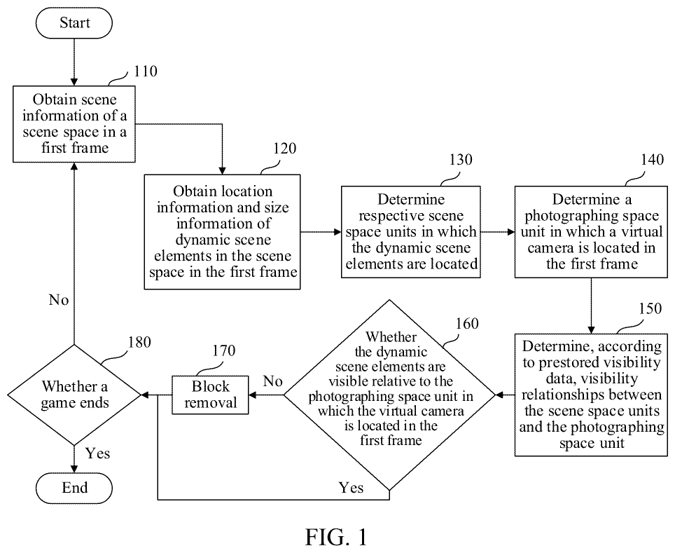

FIG. 1 is a flowchart of a method for rendering a scene picture according to an embodiment of the present disclosure. The method may include the following operations.

Operation 110: Obtain scene information of a scene space.

The scene information includes scene elements included in the scene space.

Operation 120: Obtain location information and size information of dynamic scene elements in the scene space.

Operation 130: Determine, according to the location information and the size information of the dynamic scene elements in the scene space, respective scene space units in which the dynamic scene elements are located.

Operation 140: Determine a photographing space unit in which a virtual camera is located.

Operation 150: Determine, according to prestored visibility data, visibility relationships between the respective scene space units in which the dynamic scene elements are located and the photographing space unit in which the virtual camera is located.

Operation 160: Determine whether the dynamic scene elements are visible relative to the photographing space unit in which the virtual camera is located in a first frame; if so, perform operation 170; or if not, perform operation 180.

Operation 170: Perform block removal on a dynamic scene element which is invisible relative to the photographing space unit in which the virtual camera is located in the first frame.

Operation 180: Determine whether a game ends; if so, end the operation; or if not, perform operation 110.

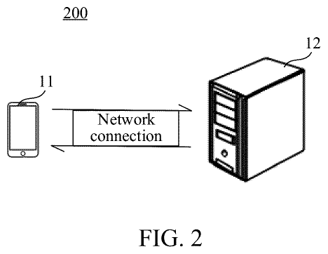

FIG. 2 is a schematic diagram of an implementation environment according to an embodiment of the present disclosure. The implementation environment may be implemented as a system for rendering a scene picture. As shown in FIG. 2, a system 200 may include a terminal device 11.

A target application program, such as a client of a target application program, is installed and run in the terminal device 11. In one embodiment, a user account is logged in the client. The terminal device is an electronic device having capabilities of data computing, processing, and storage. The terminal device may be a smart phone, a tablet computer, a personal computer (PC), a wearable device, etc., which is not limited in the embodiments of the present disclosure. The target application program may be a game application program, such as a shooting game application program, a multiplayer gunfight survival game application program, a battle royale survival game application program, a location based service (LBS) game application program, and a multiplayer online battle arena (MOBA) game application program, which are not limited in the embodiments of the present disclosure. The target application program may alternatively be any application program having a function of rendering a scene picture, such as a social application program, a payment application program, a video application program, a music application program, a shopping application program, and a news application program. In the method provided in the embodiments of the present disclosure, the operations may be performed by the terminal device 11, for example, by a client run in the terminal device 11.

In some embodiments, the system 200 further includes a server 12, a communication connection (for example, a network connection) is established between the server 12 and the terminal device 11, and the server 12 is configured to provide a background service for the target application program. The server may be an independent physical server, or a server cluster or a distributed system formed by a plurality of physical servers, or a cloud server providing a cloud computing service. The operations of the method provided in the embodiments of the present disclosure may alternatively be performed by the terminal device 11 and the server 12 alternately, which is not specifically limited in the embodiments of the present disclosure. For example, the server 12 may be configured to pre-generate and store the following visibility data; and the terminal device 11 may query the visibility data from the server 12 in real time, or may download and save the visibility data from the server 12, determine visibility of scene elements based on the visibility data, and render and display a scene picture. Still for example, the server 12 may be configured to pre-generate and store the following visibility data, determine visibility of scene elements based on the visibility data, and then transmit visibility results of the scene elements to the terminal device 11; and the terminal device 11 is configured to render and display a scene picture according to the visibility results obtained from the server 12.

The following describes the technical solution of the present disclosure by using several embodiments.

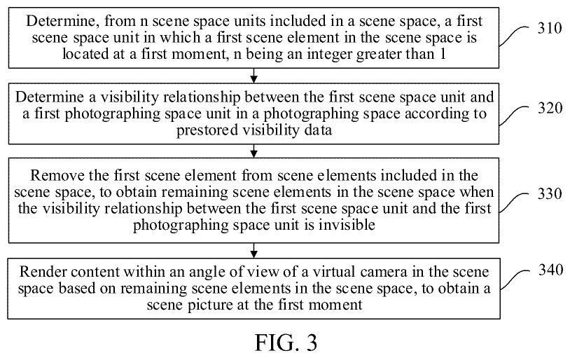

FIG. 3 is a flowchart of a method for rendering a scene picture according to an embodiment of the present disclosure. In this embodiment, a description is provided by an example in which the method is applied to the terminal device described above. The method may include the following operations (310 to 340).

Operation 310: Determine, from n scene space units included in a scene space, a first scene space unit in which a first scene element in the scene space is located at a first moment, n being an integer greater than 1.

In some embodiments, the scene space is a three-dimensional space, which refers to a spatial region in which a scene element may be located, and is divided into n three-dimensional scene space units. The scene space may include only a dynamic scene element or only a static scene element, and may include both static and dynamic scene elements. The dynamic scene element refers to a scene element having the location in the scene space being not fixed. For example, the dynamic scene element may indicate an element that is present in the scene space or is not be present in the scene space, such as a special effect element or a prop element that only appears after a user operates or completes a task. Still for example, the dynamic scene element may alternatively refer to a scene element having the location in the scene space being variable, such as a virtual object, a virtual vehicle, or a virtual special effect in the scene space. The static scene element refers to a scene element that always exists in a scene space and does not change in location relative to the scene space, such as a virtual building, a virtual rock, a virtual wall, a virtual sculpture, and a virtual hillside in the scene space.

In some embodiments, sizes and/or shapes of different scene space units may be the same, or may be different. In other words, the scene space may be evenly divided into n scene space units having the same shape and the same size, or the n scene space units may be obtained by division according to a plurality of shape and/or size parameters. The scene space unit may be a cube, or a cuboid, or may be of another shape, which is not specifically limited in the embodiments of the present disclosure.

In some embodiments, the scene space unit in which the first scene element is located at the first moment is referred to as a first scene space unit. The first moment is after a current moment, or the first moment is the current moment.

Operation 320: Determine a visibility relationship between the first scene space unit and a first photographing space unit in a photographing space according to prestored visibility data.

In some embodiments, the visibility data includes visibility relationships between the n scene space units and m photographing space units included in the photographing space, the first photographing space unit refers to a photographing space unit in which a virtual camera is located at the first moment, and m is an integer greater than 1.

In some embodiments, the location of the virtual camera may be variable, and the photographing space refers to a spatial region in which the virtual camera may be located. In some embodiments, the photographing space refers to a photographing space corresponding to the scene space. That is, a spatial region of the scene space can be observed through the virtual camera. There may be an overlapped region between the photographing space and the scene space. In other words, there may be overlapped or superposed photographing space unit and scene space unit. Certainly, there may be no overlapped regions between the photographing space and the scene space. The photographing space may be divided into m photographing space units. In one embodiment, the different photographing space units have the same shape and size. The photographing space unit in which the virtual camera is located at the first moment is referred to as a first photographing space unit.

In some embodiments, the visibility relationships between the n scene space units and the m photographing space units may be prestored as visibility data. In this way, in an actual process of rendering a scene picture, a visibility relationship between a particular scene space unit and a particular photographing space unit can be obtained by directly querying the visibility data. For example, the visibility relationship between the first scene space unit and the first photographing space unit is determined by looking up the visibility data.

Operation 330: Remove the first scene element from scene elements included in the scene space, to obtain remaining scene elements in the scene space when the visibility relationship between the first scene space unit and the first photographing space unit is invisible.

In some embodiments, the visibility relationship between the scene space unit and the photographing space unit has at least the following two cases: visible and invisible. When the first scene space unit is invisible relative to the first photographing space unit, it means that the scene elements included in the first scene space unit at the first moment are invisible relative to the virtual camera at the first moment. That is, the first scene element is invisible relative to the virtual camera at the first moment. In other words, at the first moment, at an angle of view formed by the location and posture of the virtual camera, the first scene element is blocked or goes beyond the angle of view of the virtual camera. That is, a user cannot see the first scene element at the angle of view. Therefore, in the process of rendering the scene picture at the first moment, block removal needs to be performed on the first scene element, that is, the first scene element is not rendered.

In a process of rendering a game, objects in a scene space are observed from the location of a virtual camera. When a scene element falls within an angle-of-view range of the virtual camera, but is blocked by another opaque scene element, the blocked scene element is invisible to the virtual camera. However, a computer device rendering pipeline still renders the scene element, resulting in unnecessary performance overhead. If these blocked scene elements can be excluded from a rendering queue and not rendered, the process is referred to as block removal. Significantly, in this way, the performance overhead required for rendering can be reduced.

Operation 340: Render content within an angle of view of the virtual camera in the scene space based on the remaining scene elements in the scene space, to obtain a scene picture at the first moment.

In some embodiments, a range of the spatial region that can be observed by the virtual camera is correlated with the location of the virtual camera (for example, the photographing space unit in which the virtual camera is located) and the angle of view of the virtual camera. After the first scene element is removed, content within the angle of view of the virtual camera in the remaining scene elements is rendered, and scene elements beyond the angle of view of the virtual camera are not rendered, so that the scene picture at the first moment is obtained.

In conclusion, in the technical solution provided by the embodiments of the present disclosure, by prestoring a visibility relationship between a scene space unit and a photographing space unit in a form of visibility data, in an actual rendering process of a scene picture, after determining a scene space unit in which a scene space element is located and a photographing space unit in which a virtual camera is located, a visibility relationship between the scene space element and the virtual camera can be determined and a scene picture can be rendered by querying the visibility data. Therefore, the visibility of a scene element does not need to be calculated in real time, and the efficiency of determining the visibility of the scene element is improved, thereby further improving the rendering efficiency of the scene picture.

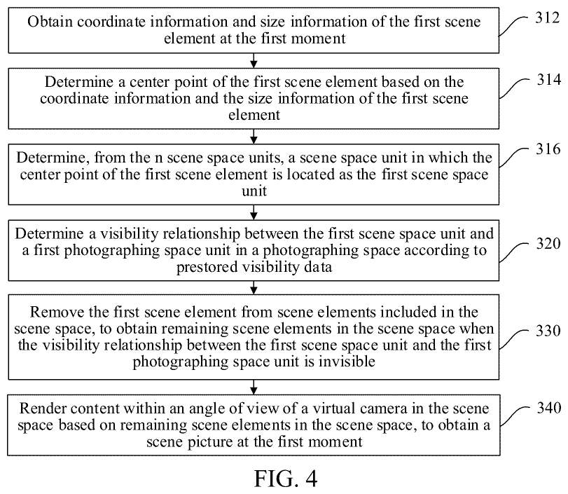

In some possible implementations, as shown in FIG. 4, operation 310 in the embodiment of FIG. 3 can be replaced by the following operations (312 to 316).

Operation 312: Obtain coordinate information and size information of the first scene element at the first moment.

In some embodiments, the coordinate information of the first scene element includes coordinates of the first scene element in a coordinate system corresponding to the scene space. In some embodiments, the scene space is a part of space in a virtual world, the virtual world includes a plurality of scene spaces, and the coordinate information of the first scene element may alternatively include coordinates of the first scene element in a world coordinate system of the virtual world. In some embodiments, the coordinate information of the first scene element may alternatively include an offset of the first scene element relative to a reference location (for example, a center of the scene space or the virtual world, or a starting point of the scene space or the virtual world).

In some embodiments, sizes of different scene elements may be different, and a size of a same scene element at different times may also differ (for example, a virtual prop or a virtual pet having the shape or volume being variable under different conditions). The size information of the first scene element may include a height, a width, and a length of the first scene element.

Operation 314: Determine a center point of the first scene element based on the coordinate information and the size information of the first scene element.

In some embodiments, the coordinate information of the center point of the first scene element may be calculated according to the coordinate information and the size information of the first scene element. For example, if the coordinate information of the first scene element includes the coordinate information of the center point of the first scene element, the center point of the first scene element may be directly determined. Still for example, if the coordinate information of the first scene element includes the coordinate information of a center at a bottom surface of the first scene element, a location of the center point of the first scene element can be obtained by adding a half height of the first scene element to the coordinate information of the center at the bottom surface of the first scene element.

Operation 316: Determine, from the n scene space units, a scene space unit in which the center point of the first scene element is located as the first scene space unit.

In some embodiments, operation 316 further includes the following operations.

1. Determine an offset of the center point of the first scene element relative to a starting point of the scene space at the first moment in at least one spatial dimension.

2. Divide, for each spatial dimension among the at least one spatial dimension, the offset corresponding to the dimension by a size of the scene space unit in the dimension, to obtain a quantity of scene units between the starting point and the center point in the spatial dimension.

3. Determine the first scene space unit in which the first scene element is located based on the quantity of scene units between the starting point and the center point in each spatial dimension.

In some embodiments, quantities of scene space units between the center point and the starting point in spatial dimensions are calculated. For example, if the offset (the offset is a number greater than or equal to 0) corresponding to a dimension is divided by the size of the scene space unit in the dimension, an obtained calculation result is a; if a is an integer, the quantity of scene space units between the center point and the starting point in the spatial dimension is determined as a; and if a is a decimal, it is determined that the quantity of scene space units between the center point and the starting point in the spatial dimension is the integer part of a+1. Exemplarily, if there are three spatial dimensions in the scene space, respectively, an X-axis dimension, a Y-axis dimension, and a Z-axis dimension, and the quantities of scene space units between the starting point and the center point in these three dimensions obtained through calculation are respectively x, y, and z, an x^{th} scene space unit along the X-axis, a y^{th} scene space unit along the Y-axis, and a z^{th} scene space unit along the Z-axis calculated from the starting point are determined as the scene space units in which the first scene element is located, that is, the first scene space units. In this way, for a scene element having the location being dynamically variable, the scene unit at the corresponding moment can be simply calculated according to the offset, thereby reducing computing resources required for rendering a scene in which the dynamic scene element exists, and improving the rendering efficiency of the scene.

In the implementation, a scene space unit in which the scene element is located is determined based on a center point of the scene element at a particular moment, so that the determined scene space unit is a scene space unit mainly occupied by the scene element as far as possible, thereby improving the accuracy of determining of the scene space unit.

In the implementation, the scene space units in which the scene element is located are determined based on the offset of the center point of the scene element relative to the starting point of the scene space and sizes of the scene space units in spatial dimensions, so that it is not necessary to prestore coordinate ranges corresponding to the scene space units, thereby saving storage resources required for determining the scene space units in which the scene element is located.

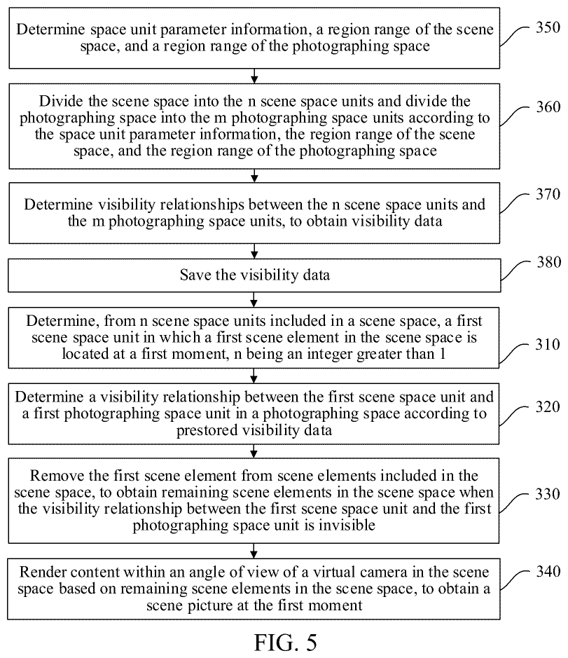

In some possible implementations, as shown in FIG. 5, the following operations (350 to 380) are included before operation 320 in the embodiment of FIG. 3.

Operation 350: Determine space unit parameter information, a region range of the scene space, and a region range of the photographing space.

The space unit parameter information includes size parameters of the photographing space units and the scene space units.

In some embodiments, in a stage of determining the visibility data, by determining the region range of the scene space and the region range of the photographing space, the space of which region range is to be divided into scene space units, and the space of which region range is to be divided into photographing space units can be determined. By determining the space unit parameter information, the size parameters of the photographing space units and the scene space units are determined. In some embodiments, the size parameters of the photographing space units and the scene space units may be the same, or may be different.

In some embodiments, the sizes of the scene space units are correlated with at least one of the following: a ground surface type of the scene space, and a maximum size of a scene element in the scene space.

In some embodiments, the sizes of the scene space units are determined according to the ground surface type of the scene space. In one embodiment, sizes/volumes of scene space units in a scene space in which a ground surface is relatively void may be greater than sizes/volumes of scene space units in a scene space in which a ground surface is distributed with dense objects. For example, sizes/volumes of scene space units in a grassland scene space may be greater than sizes/volumes of scene space units in a forest scene space; and sizes/volumes of scene space units in a forest scene space may be greater than sizes/volumes of the scene space units in a town scene space.

In some embodiments, the sizes of the scene space units are determined according to a maximum scene element that may exist in the scene space. In one embodiment, the maximum scene element that may exist in the scene space may be entirely placed in one scene space unit. In one embodiment, the volume of the scene space unit is greater than or equal to the volume of the maximum scene element that may exist in the scene space.

In some embodiments, the photographing space unit is also a three-dimensional space unit, which may be a cuboid or a cube, or may be of another three-dimensional shape, which is not specifically limited in the embodiments of the present disclosure. In some embodiments, the sizes of the scene space units are set according to the ground surface type of the scene space and/or the maximum size of the scene element in the scene space, so that the sizes of the scene space units are adapted to a landmark type or the scene element, thereby further enabling the size setting of the scene space units to be more flexible.

Operation 360: Divide the scene space into the n scene space units and divide the photographing space into the m photographing space units according to the space unit parameter information, the region range of the scene space, and the region range of the photographing space.

In some embodiments, after determining the region range of the scene space, the scene space is divided according to the size parameters of the scene space units, to generate n scene space units; and after the region range of the photographing space is determined, the photographing space is divided according to the size parameters of the photographing space units, to generate m photographing space units.

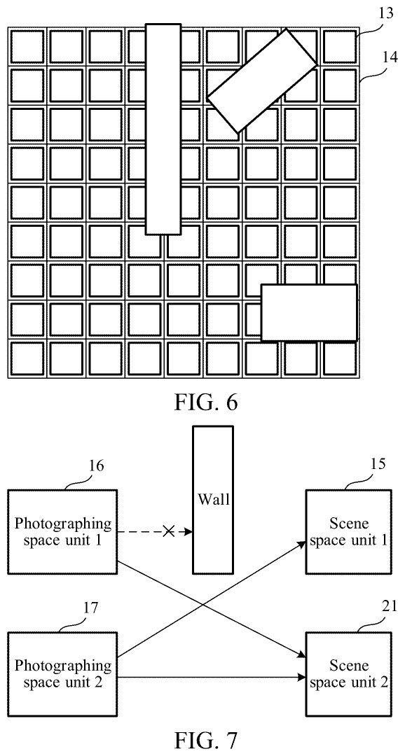

As shown in FIG. 6, when the size parameters of the photographing space units and the scene space units are the same, division results of the photographing space units and the scene space units may be the same, that is, a photographing space unit 13 and a scene space unit 14 are overlapped.

Operation 370: Determine visibility relationships between the n scene space units and the m photographing space units, to obtain visibility data.

In some embodiments, a visibility relationship between each scene space unit and each photographing space unit needs to be determined. In other words, n×m visibility relationships need to be determined. In one embodiment, if a scene space unit is invisible relative to a photographing space unit, the corresponding visibility relationship may be indicated by 0; and If a scene space unit is visible relative to a photographing space unit, the corresponding visibility relationship may be represented by 1.

In some embodiments, as shown in FIG. 7, a scene space unit 15 is invisible relative to a photographing space unit 16 due to block by a wall; due to non-block by a wall, the scene space unit 15 is visible relative to a photographing space unit 17, a scene space unit 21 is visible relative to a photographing space unit 16, and the scene space unit 21 is visible relative to the photographing space unit 17.

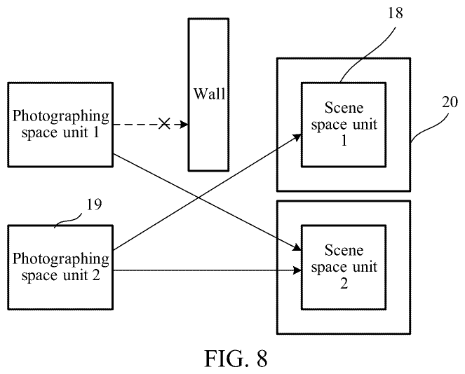

In some embodiments, as shown in FIG. 8, a visibility relationship between a scene space unit 18 and a photographing space unit 19 is determined according to a visibility relationship between a magnification space unit 20 corresponding to the scene space unit 18 and the photographing space unit 19. The magnification space unit 20 is a space unit having a size greater than that of the scene space unit 18 and including the scene space unit. In this embodiment, the visibility relationship between the scene space unit and the photographing space unit is determined according to the visibility relationship between the magnification space unit corresponding to the scene space unit and the photographing space unit, so that for a scene element having the size exceeding the scene space unit, whether the scene element is visible can be obtained more accurately.

In some embodiments, a side length of the magnification space unit is equal to a sum of a side length of the scene space unit and a length of a maximum dynamic scene element, and the maximum dynamic scene element refers to a dynamic scene element having a maximum size in the virtual environment. In this way, it can be ensured that each amplification scene space unit can entirely accommodate all individual dynamic scene elements in the scene, thereby avoiding the situation in which the dynamic scene elements exceed the magnification space unit and further no matter whether a dynamic scene element is removed or retained, the dynamic scene element is complete, that is, either entirely removed or entirely retained, so as to avoid the situation in which only a part of the dynamic scene element is retained.

Operation 380: Save the visibility data.

In some embodiments, binary sequences are used to represent the visibility relationships between the scene space units and the photographing space units, and each binary sequence corresponds to one photographing space unit. Therefore, the visibility data includes m binary sequences, and each binary sequence is used for indicating visibility relationships between n scene space units and a same photographing space unit. In other words, the visibility data is stored in accordance with the photographing space units, and each photographing space unit corresponds to one binary sequence.

In some embodiments, the binary sequence includes at least n bits, and a value at each bit is a first value or a second value. The first value is used for indicating that a visibility relationship between a scene space unit corresponding to the bit and the photographing space unit is invisible, and the second value is used for indicating that the visibility relationship between the scene space unit corresponding to the bit and the photographing space unit is visible. In one embodiment, the first value is 0, and the second value is 1. The first value and the second value may alternatively be other values, and the values may be specifically set by a person of the related art according to an actual situation, which is not specifically limited in the embodiments of the present disclosure. In this embodiment, two relationships, namely, visible and invisible, are indicated by two values, which is convenient, quick, and clear, and the values occupy a few of bits, thereby saving the storage space.

In some embodiments, the visibility data includes m binary sequences, and each binary sequence is used for indicating visibility relationships between n scene space units and a same photographing space unit. Therefore, the visibility data is indicated and stored clear and orderly, thereby improving the convenience of subsequent search and use of the visibility data.

In some embodiments, operation 380 further includes the following operations.

1. Perform clustering on the m binary sequences according to Hamming distances between the binary sequences and a central sequence, to obtain K cluster sets, K being a positive integer, where the Hamming distances each refers to a quantity of corresponding bits having different values between each binary sequence and the central sequence.

2. Determine, for each cluster set among the K cluster sets, a central sequence corresponding to the cluster set according to binary sequences included in the cluster set.

3. Indicate, for each cluster set, the binary sequences included in the cluster set by the central sequence corresponding to the cluster set instead when the central sequence corresponding to the cluster set meets a clustering stopping condition.

4. Save compressed visibility data, where

the compressed visibility data includes central sequences corresponding to the K cluster sets; and indicate visibility relationships between a plurality of photographing space units corresponding to a cluster set to which each central sequence pertains and the n scene space units by the visibility relationships between the photographing space unit indicated by the central sequence and the n scene space units instead. By saving the compressed data, the storage resources required for storing the visibility data can be reduced.

In some embodiments, in the process of clustering the m binary sequences, distances between the binary sequences and central sequences respectively corresponding to the K cluster sets need to be calculated, based on which the K cluster sets are updated. In the embodiments of the present disclosure, respective calculation of Hamming distances between each binary sequence in the binary sequence set and the K central sequences is used to replace calculation of Euclidean distances between data points in a conventional K-means clustering algorithm. On the premise that the binary sequences and the K central sequences have equal-length bits, the Hamming distances each refers to a quantity of corresponding bits having different values between each binary sequence and the central sequence. For example, from two equal-length binary sequences 11001101 and 01011101, it can be seen that the two sequences only have different values at the first and fourth bits. Therefore, the Hamming distance between the two binary sequences is 2. A smaller quantity of bits having different values between two sequences indicates a smaller Hamming distance and a higher similarity between the two sequences; on the contrary, a larger quantity of bits having different values indicates a larger Hamming distance and a smaller similarity between the two sequences. If the two sequences have no different values at corresponding bits, the Hamming distance is 0, which means that the two binary sequences are exactly the same.

For each central sequence among the K central sequence, calculation of the Hamming distance can be implemented by performing XOR operations on values at corresponding bits of the binary sequence and the central sequence, to obtain a binary result sequence. The binary result sequence is formed by XOR values of the XOR operations. If the values at the corresponding bits are the same, the XOR value is 0; or if the values at the corresponding bits are different, the XOR value is 1. A quantity of XOR values being 1 in the binary result sequence is determined as the Hamming distance between the binary sequence and the central sequence.

For example, in the two equal-length binary sequences 11001101 and 01011101, if an XOR operation is performed on a value at each corresponding bit, an XOR value can be obtained at each corresponding bit. If the values at the corresponding bits are the same, the XOR value is 0; or if the values at the corresponding bits are different, the XOR value is 1. Therefore, a binary result sequence having a same length as the two binary sequences is obtained, and the Hamming distance between the two binary sequences is obtained by counting a quantity of 1's in the result sequence. In the two equal-length binary sequences 11001101 and 01011101 in the foregoing example, only values at the first and fourth bits are different, the result sequence after the XOR operations is 10010000, and there are two 1's in the result sequence. Therefore, the Hamming distance between the binary sequences 11001101 and 01011101 is 2. The Hamming distance between two binary sequences is calculated by performing XOR operations on the values at the corresponding bits between the binary sequences, and therefore, the problem that an Euclidean distance in a K-means clustering algorithm cannot be applied to distance calculation in a form of binary sequences is solved.

After the K cluster sets are updated, respective central sequences corresponding to the K cluster sets need to be calculated again. In some embodiments, for each cluster set among the K cluster sets, a value at an i^{th} bit of an updated central sequence of the cluster set may be determined according to values at i^{th} bits of respective binary sequences included in the cluster set, i being a positive integer. The updated central sequence of the cluster set is determined according to values at bits of the central sequence of the cluster set after the updating.

In some embodiments, a first quantity and a second quantity are determined according to values at i^{th} bits of the binary sequences included in the cluster set, where the first quantity is a quantity of binary sequences having a value 1 at the i^{th} bits, the second quantity is a quantity of binary sequences having a value 0 at the i^{th} bits, and i is a positive integer; a value at the i^{th} bit of the central sequence corresponding to the cluster set is determined according to a size relationship between the first quantity and the second quantity; and the central sequence corresponding to the cluster set is determined according to values at bits of the central sequence corresponding to the cluster set.

In a conventional K-means clustering algorithm, an algorithm in which an average of dimension values of all data points in each category is taken as a center point is usually used after each clustering iteration, but this algorithm cannot be applied to the situation in which the data points are in a form of binary sequences. Therefore, in order to adapt to the situation in which the data points are in a form of binary sequences, the algorithm of the center point is also adjusted accordingly, and the obtained center point is a binary sequence having the same length as the binary sequence set other than a conventional data point. A value at the i^{th} bit of the updated central sequence of the cluster set may be determined according to distribution of values at i^{th} bits of all binary sequences in the cluster set. The value at each bit of a binary sequence is only 0 or 1, and values at i^{th} bits of all binary sequences in a cluster set can be taken out separately for classification, values 1 are grouped into a category, and values 0 are grouped into another category, and then, whether a value at an i^{th} bit of the updated central sequence is to be 0 or 1 is determined according to a size relationship between a quantity of values 1 and a quantity of values 0. After all values at all bits of the updated central sequence in the cluster set are taken, a determined updated central sequence can be obtained, and the updated central sequence becomes a new central sequence of the cluster set.

In some embodiments, if the first quantity is greater than or equal to the second quantity, it is determined that the value at the i^{th} bit of the updated central sequence of the cluster set is 1; if the first quantity is less than the second quantity, it is determined that the value at the i^{th} bit of the updated central sequence of the cluster set is 0; or, if the first quantity is greater than the second quantity, it is determined that the value at the i^{th} bit of the updated central sequence of the cluster set is 1; or if the first quantity is less than or equal to the second quantity, it is determined that the value at the i^{th} bit of the updated central sequence of the cluster set is 0.

Whether the value at the i^{th} bit of the updated central sequence of the cluster set is to be 0 or 1 may be determined by comparing a quantity of values 0 and a quantity of values 1 and taking the value of the larger one. For example, if a quantity of values at i^{th} bits of all binary sequences in a cluster set being 1 is greater than that of being 0, a value at an i^{th} bit of an updated central sequence may be 1; or on the contrary, if a quantity of values at i^{th} bits of all binary sequences in a cluster set being 0 is greater than that of being 1, a value at an i^{th} bit of an updated central sequence may be 0. In addition, if a quantity of values at i^{th} bits of all binary sequences in a cluster set being 1 is equal to that of being of 0, a value at an i^{th} bit of an updated central sequence may be 1, or the value at the i^{th} bit of the updated central sequence may be 0; this can be set by relevant technicians according to actual conditions, which is not specifically limited in the embodiments of the present disclosure. The value 0 and the value 1 have different meanings in different application scenarios, and according to a conservative policy of a clustering algorithm, the values 0 and 1 may be biased according to different application scenarios, and there is no definite value taking standard. For example, if the meanings of 0 and 1 indicate the visibility, 0 indicates invisible, and 1 indicates visible, when a quantity of values at the i^{th} bits being 1 is equal to a quantity of values at the i^{th} bits being 0, a user of the clustering algorithm may be more inclined to take the value 1, that is, indicating visible, which is more in line with the application of an actual scenario. Assuming that a central sequence is calculated for four equal-length binary sequences, 10010100, 11010100, 11011101, and 00010111, the value at the first bit of the central sequence needs to take a value having a larger amount at first bits of the four binary sequences, that is, the value 1. For the values at the second bits, due to the fact that the quantity of values being 0 is equal to the quantity of values being 1, the value at the second bit can be 1; and values can be taken continuously by the method, so that a central sequence 11010101 is obtained. By taking the value having a larger amount at i^{th} bits of all binary sequences in the cluster set as the value at the i^{th} bit of the updated central sequence, the problem that the calculation method for a center point in the K-means clustering algorithm cannot be applied to calculation of a central sequence in a form of a binary sequence is solved.

In some embodiments, after determining K cluster sets as a clustering result of a binary sequence set, the method further includes: determining, for each cluster set among the K cluster sets, an updated central sequence of the cluster set as a compressed sequence of the cluster set, where binary sequences included in the cluster set are indicated by the compressed sequence of the cluster set.

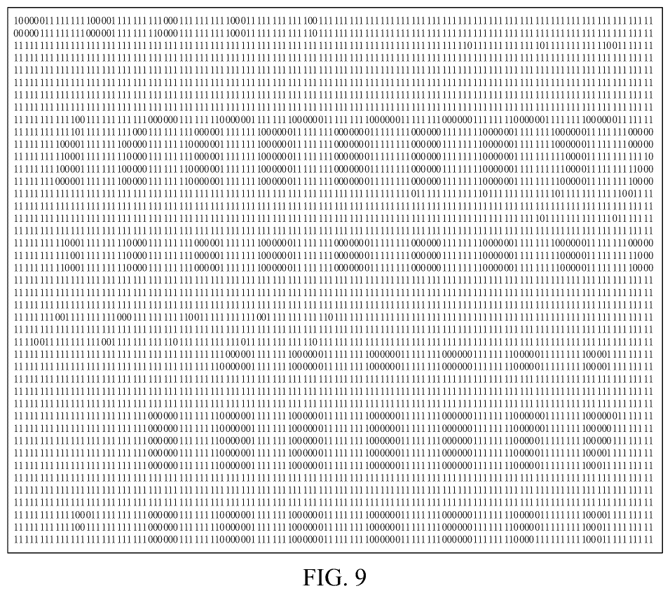

After the binary sequence set is clustered by using the K-means clustering algorithm, a data fragment after the clustering shown in FIG. 9 can be obtained, where values at all bits of the binary sequences in each cluster set have a high degree of similarity. Compression of binary sequences after clustering is implemented by compressing each cluster set separately, and the binary sequences in each cluster set can be uniformly compressed into the central sequence of the cluster set, that is, the updated central sequence of the cluster set is used to represent all the binary sequences in the cluster set. Therefore, the volume of the compressed data is greatly reduced, which is conducive to saving the data storage space and can be applied to the situation of large amount of data information in the computer field; moreover, by using a unified central sequence to represent all the binary sequences in the cluster set, during read of data, it is not necessary to locate a particular binary sequence in the cluster set, so that the process of data locating is simplified, the central sequence of the cluster set is directly read, and the data reading is faster and more convenient. Specific implementation of a compression volume, reference may be made to the following example. If the storage space occupied by each binary sequence before clustering is X, the storage unit of X may be a bit, a byte (B), a kilobyte (KB), a megabyte (MB), or the like. If a total quantity of entries of a binary sequence is M and M is an integer greater than 1, a total storage space occupied by the binary sequence before clustering is X×M. Assuming that all binary sequences are grouped into K groups according to clustering results and K is a positive integer much smaller than M, after clustering is completed, the storage space occupied by the compressed binary sequences is X×K, and in this case, the data volume of the binary sequences after the clustering can be compressed to K/M of that before the clustering. For example, assuming that the value of number K of the cluster sets is 100 and the total quantity of binary sequence entries included in the binary sequence set is 10000, the binary sequence data can be compressed to 1/100 of the original. In other words, the data is compressed hundreds of times to save the data storage space.

In some embodiments, the compressed visibility data includes K compressed sequences (that is, central sequences) obtained based on the K cluster sets. The visibility relationship between the scene space unit and the photographing space unit indicated by each compressed sequence may be used to indicate the visibility relationships between all photographing space units and scene space units corresponding to the cluster set.

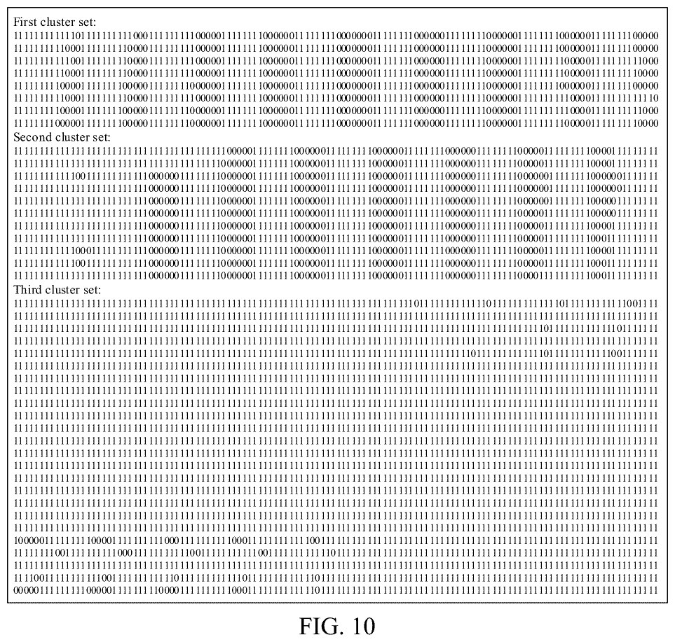

However, the use of one central sequence to uniformly represent all binary sequences in the cluster set may have a particular data bias, which is inevitable in a compression process. For example, in the third cluster set in FIG. 10, the values at the first bits include twenty-three 1's and one 0, and in this case, the value at the first bit of the central sequence is certainly 1. After the third cluster set is compressed, the values at the first bits of all binary sequences in the third cluster set is indicated by 1; therefore data bias is generated for the binary sequence originally having the value 0 at the first bit, and a data loss is generated during compression of the cluster set. Moreover, for each cluster set, the use of a unified central sequence to indicate all binary sequences is bound to generate data bias, and a compressed central sequence also has a particular amount of data loss. This compression method is actually a lossy compression method. Therefore, while data compression is performed and more data can be stored in the same storage space, it is also necessary to accept that some of the data is lost.

Therefore, the K cluster sets determined in the previous operations are not necessarily a final clustering result. The final clustering result of the method for clustering binary sequences provided in the present disclosure needs to meet two conditions: first, the data volume after compression needs to fall within a preset volume range of a storage space (that is, the data volume after compression cannot be excessively large); and second, the data loss generated in the compression process needs to fall within a preset loss range (that is, the data loss generated in the compression process cannot be excessively large). A clustering result that meets the above-mentioned two conditions can be counted as achieving the clustering effect of the clustering method of the present disclosure. If the K cluster sets determined by the above-mentioned operations meet only one of the conditions, for example, only the compressed data volume falls within the preset storage range, or only the data loss generated during compression falls within the preset loss range, or, the K cluster sets meets neither of the two conditions (that is, the compressed data volume exceeds the preset storage range and the data loss generated in the compression process also exceeds the preset loss range), the value of K needs to be adjusted, to re-cluster the binary sequence set, until the K cluster sets obtained by clustering not only meet that the compressed data volume falls within the preset storage range, but also meet that the data loss generated in the compression process falls within the preset loss range; in this case, the K cluster sets can be determined as a final clustering result of the binary sequence set.

In some embodiments, the scene space is a space which a dynamic scene element in a virtual environment probabilistically reaches, and each binary sequence includes a first sequence section and a second sequence section, where the first sequence section is used for indicating the visibility relationships between the n scene space units and the same photographing space unit, and the second sequence section is used for indicating a visibility relationship between at least one static scene element and a same photographing space unit in the virtual environment. In other words, each binary sequence is composed of a first sequence section and a second sequence section. The first sequence section is used for indicating a visibility relationship between a scene space unit which a dynamic scene element probably reaches and a photographing space unit to which the binary sequence corresponds. The second sequence section is used for indicating a visibility relationship between a static scene element in the scene space and a photographing space unit to which the binary sequence corresponds. In one embodiment, lengths of first sequence sections of all binary sequences are the same (that is, quantities of bits of the first sequence sections are the same); and lengths of second sequence sections of different binary sequences may be the same, or may be different. In this embodiment, an angle-of-view range of the camera is determined by using the first sequence sections, and visible static scene elements corresponding to the locations of the camera are determined by using the second sequence sections, so as to conveniently and concisely save the visibility data, and facilitate subsequent search and use of the visibility data.

In an implementation, the visibility data is prestored by pre-calculation for use during real-time rendering of a scene picture, so that occupation of processing resources caused by calculating visibility of a scene element relative to the virtual camera in a picture rendering process is avoided, thereby reducing processing resources required for rendering the scene picture, and improving the rendering efficiency of rendering the scene picture.

In some possible implementations, the scene space has k different unit division modes, different unit division modes correspond to different scene element types and different visibility data, and k is an integer greater than 1. The visibility relationship correlated with the first scene element is determined according to first visibility data, where the first visibility data is visibility data corresponding to a scene element type to which the first scene element pertains.

In some embodiments, the scene element type includes a size type of a scene element. A plurality of scene space unit division modes are prestored, and size types of scene space units corresponding to different division modes are different.

In some embodiments, the method further includes: determining a size type of a first scene element; determining, based on the size type of the first scene element, a target size of a scene space unit corresponding to the first scene element for block removal; determining a first scene space unit based on the target size; and determining a visibility relationship between the first scene space unit and the first photographing space unit according to the prestored visibility data corresponding to the first scene space unit of the target size.

In some embodiments, scene space units corresponding to different unit division modes have a same shape, but different volumes. For example, the scene space units corresponding to different unit division modes are all cubes, but side lengths of the scene space units are different. In this case, for a scene element having a relatively large size in a particular spatial dimension, visibility data corresponding to a unit division mode having a relatively long side length may be used to determine the visibility thereof; and for a scene element having relatively small sizes in spatial dimensions, visibility data corresponding to a unit division mode having a relatively small side length may be used to determine the visibility thereof.

In some embodiments, different unit division modes correspond to different shapes of the scene space units. For example, k different unit division modes include: dividing a scene space unit according to a square shape and dividing a scene space unit according to a cuboid. In this case, for scene elements having little difference in size in spatial dimensions, visibility data corresponding to a unit division mode in which a scene space unit is a cube may be used to determine the visibility thereof; and for a scene element having a size in a particular spatial dimension differing greatly from its size in another spatial dimension, visibility data corresponding to a unit division mode in which a scene space unit is a cuboid may be used to determine the visibility thereof.

In some embodiments, scene space units corresponding to different unit division modes have a same shape and a same volume, but different postures. For example, scene space units corresponding to different unit division modes are cuboids having a same shape and a same volume, but spatial dimensions corresponding to longest sides (or shortest sides) of the scene space units corresponding to the different unit division modes are different. In this case, for a scene space element having a relatively long transverse length and a relatively small height, visibility data corresponding to a unit division mode in which a scene space unit in a spatial dimension parallel to the ground has a relatively large size and a relatively small height may be used to determine the visibility thereof; and for a scene space element having a relatively large height and relatively small sizes in other spatial dimensions, visibility data corresponding to a unit division mode in which a size, of a scene space unit, in a spatial dimension parallel to the ground has a relatively small size and a relatively high height may be used to determine the visibility thereof.

In an implementation, by generating and saving a variety of different unit division modes and corresponding visibility data in advance, in an actual rendering process, a most appropriate unit division mode and corresponding visibility data can be selected according to a scene element type (for example, a size type) of a scene element, for determining a visibility relationship of the scene element, thereby improving the adaptability between the scene space unit and the scene element, and further improving the display precision of the scene element and the scene picture.

In some possible implementations, after operation 340, the method may further include the following operations.

1. Determine, from the n scene space units included in the scene space, a second scene space unit in which a second scene element in the scene space is located at a second moment, where the second moment is after the first moment and the second scene element is a scene element that exists in the scene space at the second moment.

2. Determine a visibility relationship between the second scene space unit and a second photographing space unit in the photographing space according to the visibility data, where the second photographing space unit refers to a photographing space unit in which the virtual camera is located at the second moment;

3. Remove the second scene element from the scene elements included in the scene space, to obtain the remaining scene elements in the scene space when the visibility relationship between the second scene space unit and the second photographing space unit is invisible.

4. Render content within the angle of view of the virtual camera in the scene space based on the remaining scene elements in the scene space, to obtain a scene picture at the second moment.

In an implementation, after the scene picture at the first moment is obtained, block removal processing is performed on the scene element in the scene space at a moment after the first moment, to obtain a scene picture at the moment after the first moment. For example, after the scene picture of a particular frame is obtained by rendering, the scene picture of a next frame is continuously rendered according to the content described above. In this way, continuous scene pictures in the scene space can be continuously obtained by continuous rendering, so that dynamic display of the scene pictures can be implemented.

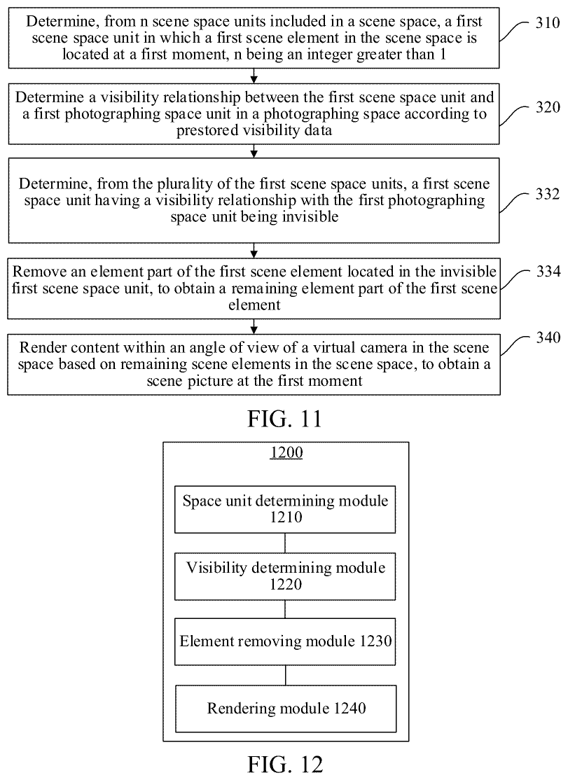

In some possible implementations, the first scene element may occupy a quantity of first scene space units. As shown in FIG. 11, operation 330 in FIG. 3 can be replaced with the following operations (332 to 334).

Operation 332: Determine, from the plurality of the first scene space units, a first scene space unit having a visibility relationship with the first photographing space unit being invisible.

Operation 334: Remove an element part of the first scene element located in the invisible first scene space unit, to obtain a remaining element part of the first scene element, where

the remaining scene elements in the scene space include the remaining element part of the first scene element.

In an implementation, the scene space element may occupy more than one scene space unit; and therefore, an element part of the scene space unit visible relative to the first photographing space unit is retained, and an element part of the scene space unit invisible relative to the first photographing space unit is subjected to block removal, thereby implementing partial block removal of the scene space element and improving the display precision of the scene picture.

The following is an apparatus embodiment of the present disclosure, which may be used to execute the method embodiments of the present disclosure. For details not disclosed in the apparatus embodiments of the present disclosure, refer to the method embodiments of the present disclosure.

FIG. 12 is a block diagram of an apparatus for rendering a scene picture according to an embodiment of the present disclosure. The apparatus has functions of performing the embodiments of the method for rendering a scene picture. The functions may be implemented by hardware or may be implemented by hardware executing corresponding software. The apparatus may be the terminal device, or may be disposed on the terminal device. An apparatus 1200 may include: a space unit determining module 1210, a visibility determining module 1220, an element removing module 1230, and a rendering module 1240.

The space unit determining module 1210 is configured to determine, from n scene space units included in a scene space, a first scene space unit in which a first scene element in the scene space is located at a first moment, n being an integer greater than 1.

The visibility determining module 1220 is configured to determine a visibility relationship between the first scene space unit and a first photographing space unit in a photographing space according to prestored visibility data, the visibility data including visibility relationships between the n scene space units and m photographing space units included in the photographing space, the first photographing space unit referring to a photographing space unit in which a virtual camera is located at the first moment, and m being an integer greater than 1.

The element removing module 1230 is configured to remove the first scene element from scene elements included in the scene space, to obtain remaining scene elements in the scene space when the visibility relationship between the first scene space unit and the first photographing space unit is invisible.

The rendering module 1240 is configured to render content within an angle of view of the virtual camera in the scene space based on the remaining scene elements in the scene space, to obtain a scene picture at the first moment.

In some embodiments, the space unit determining module 1210 is configured to:
obtain coordinate information and size information of the first scene element at the first moment;
determine a center point of the first scene element based on the coordinate information and the size information of the first scene element; and
determine, from the n scene space units, a scene space unit in which the center point of the first scene element is located as the first scene space unit.

In some embodiments, the space unit determining module 1210 is configured to:
determine an offset of the center point of the first scene element relative to a starting point of the scene space at the first moment in at least one spatial dimension;
divide, for each spatial dimension among the at least one spatial dimension, the offset corresponding to the dimension by a size of the scene space unit in the dimension, to obtain a quantity of scene units between the starting point and the center point in the spatial dimension; and
determine the first scene space unit in which the first scene element is located based on the quantity of scene units between the starting point and the center point in each spatial dimension.

In some embodiments, the visibility data includes m binary sequences, and each binary sequence is used for indicating visibility relationships between n scene space units and a same photographing space unit.

In some embodiments, the binary sequence includes at least n bits, and a value of each bit is a first value or a second value. The first value is used for indicating that a visibility relationship between a scene space unit corresponding to the bit and the photographing space unit is invisible, and the second value is used for indicating that the visibility relationship between the scene space unit corresponding to the bit and the photographing space unit is visible.

In some embodiments, the scene space is a space which a dynamic scene element in a virtual environment probabilistically reaches, and each binary sequence includes a first sequence section and a second sequence section, where the first sequence section is used for indicating the visibility relationships between the n scene space units and the same photographing space unit, and the second sequence section is used for indicating a visibility relationship between at least one static scene element and a same photographing space unit in the virtual environment.

In some embodiments, the visibility relationship between the scene space unit and the photographing space unit is determined according to a visibility relationship between a magnification space unit corresponding to the scene space unit and the photographing space unit, where the magnification space unit is a space unit having a size greater than that of the scene space unit and including the scene space unit.

In some embodiments, a side length of the magnification space unit is equal to a sum of a side length of the scene space unit and a length of a maximum dynamic scene element, and the maximum dynamic scene element refers to a dynamic scene element having a maximum size in the virtual environment.

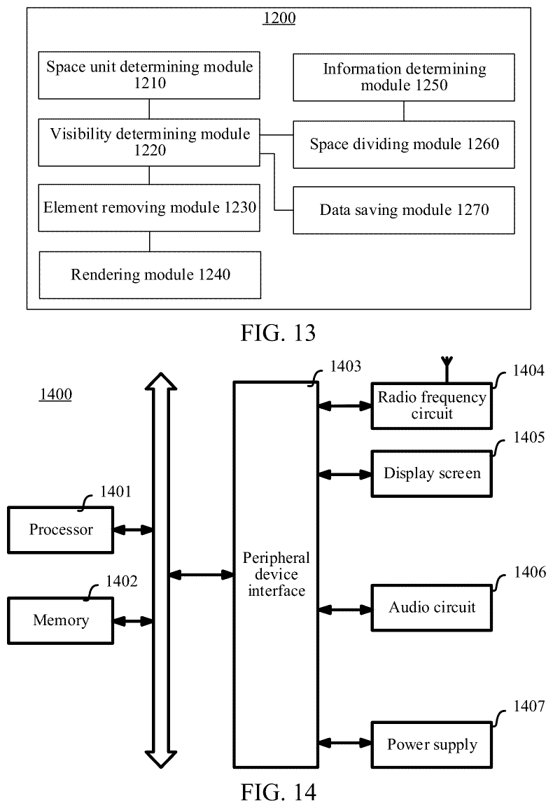

In some embodiments, as shown in FIG. 13, the apparatus 1200 further includes: an information determining module 1250, a space dividing module 1260, and a data saving module 1270.

The information determining module 1250 is configured to determine space unit parameter information, a region range of the scene space, and a region range of the photographing space, where the space unit parameter information includes size parameters of the photographing space units and the scene space units.

The space dividing module 1260 is configured to divide the scene space into the n scene space units and divide the photographing space into the m photographing space units according to the space unit parameter information, the region range of the scene space, and the region range of the photographing space.

The visibility determining module 1220 is further configured to determine the visibility relationships between the n scene space units and the m photographing space units, to obtain the visibility data.

The data saving module 1270 is configured to save the visibility data.

In some embodiments, the visibility data includes m binary sequences, and each binary sequence is used for indicating visibility relationships between n scene space units and a same photographing space unit. As shown in FIG. 13, the data saving module 1270 is configured to:
perform clustering on the m binary sequences according to Hamming distances between the binary sequences and a central sequence, to obtain K cluster sets, K being a positive integer, where the Hamming distances each refers to a quantity of corresponding bits having different values between each binary sequence and the central sequence;
determine, for each cluster set among the K cluster sets, a central sequence corresponding to the cluster set according to binary sequences included in the cluster set;
indicate, for each cluster set, the binary sequences included in the cluster set by the central sequence corresponding to the cluster set instead when the central sequence corresponding to the cluster set meets a clustering stopping condition;
save compressed visibility data, where the compressed visibility data includes central sequences corresponding to the K cluster sets; and indicate visibility relationships between a plurality of photographing space units corresponding to a cluster set to which each central sequence pertains and the n scene space units by the visibility relationships between the photographing space unit indicated by the central sequence and the n scene space units instead.

In some embodiments, as shown in FIG. 13, the data saving module 1270 is configured to:
determine a first quantity and a second quantity according to values at i^{th} bits of the binary sequences included in the cluster set, where the first quantity is a quantity of binary sequences having a value 1 at the i^{th} bits, the second quantity is a quantity of binary sequences having a value 0 at the i^{th} bits, i being a positive integer;
determine a value at the i^{th} bit of the central sequence corresponding to the cluster set according to a size relationship between the first quantity and the second quantity; and
determine the central sequence corresponding to the cluster set according to values at bits of the central sequence corresponding to the cluster set.

In some embodiments, the sizes of the scene space units are correlated with at least one of the following: a ground surface type of the scene space, and a maximum size of a scene element in the scene space.

In some embodiments, the scene space has k different unit division modes, different unit division modes correspond to different scene element types and different visibility data, and k is an integer greater than 1; and the visibility relationship correlated with the first scene element is determined according to first visibility data, where the first visibility data is visibility data corresponding to a scene element type to which the first scene element pertains.

In some embodiments, the space unit determining module 1210 is further configured to determine, from the n scene space units included in the scene space, a second scene space unit in which a second scene element in the scene space is located at a second moment, where the second moment is after the first moment and the second scene element is a scene element that exists in the scene space at the second moment.

The visibility determining module 1220 is further configured to determine a visibility relationship between the second scene space unit and a second photographing space unit in the photographing space according to the visibility data, where the second photographing space unit refers to a photographing space unit in which the virtual camera is located at the second moment;

The element removing module 1230 is further configured to remove the second scene element from the scene elements included in the scene space, to obtain the remaining scene elements in the scene space when the visibility relationship between the second scene space unit and the second photographing space unit is invisible.

The rendering module 1240 is further configured to render content within the angle of view of the virtual camera in the scene space based on the remaining scene elements in the scene space, to obtain a scene picture at the second moment.

In some embodiments, the visibility determining module 1220 is further configured to determine, from the plurality of the first scene space units, a first scene space unit having a visibility relationship with the first photographing space unit being invisible.

The element removing module 1230 is further configured to remove an element part of the first scene element located in the invisible first scene space unit, to obtain a remaining element part of the first scene element, where the remaining scene elements in the scene space include the remaining element part of the first scene element.

In conclusion, in the technical solution provided by the embodiments of the present disclosure, by prestoring a visibility relationship between a scene space unit and a photographing space unit in a form of visibility data, in an actual rendering process of a scene picture, after determining a scene space unit in which a scene space element is located and a photographing space unit in which a virtual camera is located, a visibility relationship between the scene space element and the virtual camera can be determined and a scene picture can be rendered by querying the visibility data. Therefore, the visibility of a scene element does not need to be calculated in real time, and the efficiency of determining the visibility of the scene element is improved, thereby further improving the rendering efficiency of the scene picture.

It is to be noted that: when the apparatus provided in the foregoing embodiments implements the functions of the apparatus, only division of the foregoing function modules is used as an example for description. In the practical application, the functions may be allocated to and completed by different function modules according to requirements. That is, an internal structure of the device is divided into different function modules, to complete all or some of the functions described above. In addition, the apparatus and method embodiments provided in the foregoing embodiments fall within a same conception. For details of a specific implementation process of the apparatus, refer to the method embodiments. Details are not described herein again.

FIG. 14 is a structural block diagram of a terminal device 1400 according to an embodiment of the present disclosure. The terminal device 1400 may be an electronic device such as a mobile phone, a tablet computer, a game console, an e-book reader, a multimedia playing device, a wearable device, or a PC. The terminal device is configured to implement the method for rendering a scene picture provided in the embodiments. The terminal device may be the terminal device 11 in the implementation environment shown in FIG. 3.

Generally, the terminal device 1400 includes: a processor 1401 and a memory 1402.

The processor 1401 may include one or more processing cores, for example, a 4-core processor or an 8-core processor. The processor 1401 may be implemented in at least one hardware form of a digital signal processor (DSP), a field-programmable gate array (FPGA), and a programmable logic array (PLA). The processor 1401 may alternatively include a main processor and a coprocessor, and the main processor is a processor for processing data in a wake-up state, also referred to as a central processing unit (CPU). The coprocessor is a low power consumption processor for processing data in a standby state. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations correlated with machine learning.

The memory 1402 may include one or more computer-readable storage media. The computer-readable storage medium may be non-transient. The memory 1402 may further include a high-speed random access memory and a nonvolatile memory, for example, one or more disk storage devices or flash storage devices. In some embodiments, a non-transitory computer-readable storage medium in the memory 1402 is configured to store at least one instruction, at least one program, a code set, or an instruction set, and is configured to be executed by one or more processors to implement the method for rendering a scene picture.

In some embodiments, the terminal device 1400 further includes a peripheral device interface 1403 and at least one peripheral device. The processor 1401, the memory 1402, and the peripheral device interface 1403 may be connected through a bus or a signal cable. The peripheral devices may be connected to the peripheral device interface 1403 through a bus, a signal cable, or a circuit board. Specifically, the peripheral device includes at least one of a radio frequency circuit 1404, a display screen 1405, an audio circuit 1406, and a power supply 1407.

A person skilled in the art may understand that the structure shown in FIG. 14 constitutes no limitation on the terminal device 1400, and the terminal device may include more or fewer components than those shown in the figure, or some components may be combined, or a different component deployment may be used.

In an exemplary embodiment, a computer-readable storage medium is further provided, in which at least one piece of program is stored, and when being executed by a processor, the at least one piece of program implements the method for rendering a scene picture.

In one embodiment, the computer-readable storage medium may include: a read-only memory (ROM), a random-access memory (RAM), Solid State Drives (SSDs), or an optical disc. The random access memory may include a resistance random access memory (ReRAM) and a dynamic random access memory (DRAM).

An exemplary embodiment further provides a computer program product or a computer program, the computer program product or the computer program including computer instructions, stored in a computer-readable storage medium. A processor of the computer device reads the computer instruction from the computer-readable storage medium, and the processor executes the computer instruction, so that the computer device executes the method for rendering a scene picture.

“Plurality of” mentioned in the specification means two or more. The term “and/or” describes an association relationship between associated objects, and indicates that three relationships may exist. For example, A and/or B may indicate the following cases: Only A exists, both A and B exist, and only B exists. The character “/” in this specification generally indicates an “or” relationship between the associated objects.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for rendering a scene with dynamic object elimination, performed by a processor, the method comprising:
obtaining a first scene space unit in which a dynamic scene element in a scene space is located at a first moment, wherein a first number of scene space units form the scene space;
obtaining a first photographing space unit in which a virtual camera is located in a photographing space at the first moment, wherein the first photographing space unit, wherein a second number of photographing space units form the photographing space;
determining a visibility relationship between the first scene space unit and the first photographing space unit based on prestored visibility data, wherein the prestored visibility data comprises visibility relationships between the first number of the scene space units and the second number of the photographing space units;
when the visibility relationship between the first scene space unit and the first photographing space unit is invisible, removing the dynamic scene element from scene elements comprised in the scene space and obtaining remaining dynamic scene elements in the scene space; and
rendering a scene picture in the first moment by rendering content within an angle of view of a first virtual camera in the scene space based on the remaining dynamic scene elements in the scene space.

2. The method according to claim 1, wherein the obtaining the first scene space unit comprises:
obtaining coordinate information of the dynamic scene element and size information of the dynamic scene element at the first moment;
determining a center point of the dynamic scene element based on the coordinate information of the dynamic scene element and the size information of the dynamic scene element; and
determining a scene space unit, from the first number of the scene space units, in which the center point of the dynamic scene element is located as the first scene space unit.

3. The method according to claim 2, wherein the obtaining the first scene space unit comprises:
determining an offset of the center point of the dynamic scene element relative to a starting point of the scene space at the first moment in at least one spatial dimension;
obtaining a quantity of scene units between the starting point and the center point in the at least one spatial dimension by dividing, for each spatial dimension among the at least one spatial dimension, the offset corresponding to the spatial dimension by a size of the scene space unit in the spatial dimension; and
determining the first scene space unit in which the dynamic scene element is located based on the quantity of scene units between the starting point and the center point in each spatial dimension.

4. The method according to claim 1, wherein the prestored visibility data comprises the second number of binary sequences, and each binary sequence is used for indicating first visibility relationships between the first number of the scene space units and a same photographing space unit.

5. The method according to claim 4, wherein each binary sequence comprises at least the first number of bits, a value of each bit is a first value or a second value, wherein:
the first value is used for indicating that a first visibility relationship between a scene space unit corresponding to the bit and the same photographing space unit is invisible, and the second value is used for indicating that the first visibility relationship between the scene space unit corresponding to the bit and the same photographing space unit is visible.

6. The method according to claim 5, wherein the scene space is a space which at least one dynamic scene element in a virtual environment probabilistically reaches, and each binary sequence comprises a first sequence section and a second sequence section, wherein:
the first sequence section is used for indicating the first visibility relationships between the first number of the scene space units and the same photographing space unit, and the second sequence section is used for indicating second visibility relationships between at least one static scene element and the same photographing space unit in the virtual environment.

7. The method according to claim 6, wherein the visibility relationship between the first scene space unit and the first photographing space unit is determined based on a third visibility relationship between a magnification space unit corresponding to the first scene space unit and the first photographing space unit, wherein the magnification space unit is a space unit having a size greater than that of the first scene space unit and comprising the first scene space unit.

8. The method according to claim 7, wherein a side length of the magnification space unit is equal to a sum of a side length of the first scene space unit and a length of a maximum dynamic scene element, and the maximum dynamic scene element has a maximum size in the virtual environment.

9. The method according to claim 1, wherein prior to the determining of the visibility relationship between the first scene space unit and the first photographing space unit in the photographing space according to the prestored visibility data, the method further comprises:
determining space unit parameter information, a first region range of the scene space, and a second region range of the photographing space, wherein the space unit parameter information comprises size parameters of the photographing space units and the scene space units;
dividing the scene space into the first number of the scene space units and dividing the photographing space into the second number of the photographing space units according to the space unit parameter information, the first region range, and the second region range;
obtaining visibility data by determining the visibility relationships between the first number of the scene space units and the second number of the photographing space units; and
storing the visibility data.

10. The method according to claim 9, wherein the visibility data comprises the first number of binary sequences, and each binary sequence is used for indicating the visibility relationships between the first number of the scene space units and a same photographing space unit, and wherein the storing the visibility data comprises:
obtaining cluster sets by performing clustering on the second number of binary sequences according to Hamming distances;
determining, for each cluster set, a respective central sequence corresponding to the cluster set according to binary sequences comprised in the cluster set;
for each cluster set, when the respective central sequence corresponding to the cluster set meets a clustering stopping condition, indicating the cluster set by the respective central sequence corresponding to the cluster set instead of the binary sequences comprised in the cluster set;
saving compressed visibility data, wherein the compressed visibility data comprises central sequences corresponding to the cluster sets; and
indicating third visibility relationships between a plurality of photographing space units corresponding to the cluster set to which each respective central sequence pertains and the first number of the scene space units by the fourth visibility relationships between the photographing space unit indicated by the central sequence and the first number of the scene space units instead.

11. The method according to claim 10, wherein the determining the respective central sequence corresponding to the cluster set comprises:
determining a first quantity and a second quantity according to values at i^{th} bits of the binary sequences comprised in the cluster set, wherein the first quantity is a quantity of binary sequences having a value 1 at the i^{th} bits, the second quantity is a quantity of binary sequences having a value 0 at the i^{th} bits, i being a positive integer;
determining a value at the i^{th} bits of the respective central sequence corresponding to the cluster set according to a size relationship between the first quantity and the second quantity; and
determining the respective central sequence corresponding to the cluster set according to values at bits of the respective central sequence corresponding to the cluster set.

12. The method according to claim 1, wherein sizes of the scene space units are correlated with at least one of the following: a ground surface type of the scene space, and a maximum size of a scene element in the scene space.

13. The method according to claim 1, wherein the scene space has more than one unit division modes, the more than one unit division modes corresponding to different scene element types and different visibility data; and
the visibility relationship associated with the dynamic scene element is determined according to first visibility data, wherein the first visibility data corresponds to a scene element type to which the dynamic scene element pertains.

14. The method according to claim 1, wherein the dynamic scene element is a first dynamic scene element, and wherein after the rendering the scene, the method further comprises:
determining a second scene space unit in which a second dynamic scene element in the scene space is located at a second moment, wherein the second moment is after the first moment and the second dynamic scene element is a scene element that exists in the scene space at the second moment;
determining a fifth visibility relationship between the second scene space unit and a second photographing space unit in the photographing space according to the prestored visibility data, wherein the second photographing space unit refers to a photographing space unit in which the virtual camera is located at the second moment;
removing the second dynamic scene element from the scene elements comprised in the scene space, to obtain remaining scene elements in the scene space when the fifth visibility relationship between the second scene space unit and the second photographing space unit is invisible; and
rendering content within the angle of view of the virtual camera in the scene space based on the remaining scene elements in the scene space, to obtain the scene picture at the second moment.

15. The method according to claim 14, wherein the dynamic scene element is a first dynamic scene element, and wherein the first dynamic scene element occupies a plurality of the scene space units, and the method further comprises:
determining, from the plurality of the scene space units, the first scene space unit having a visibility relationship with the first photographing space unit being invisible; and
removing an element part of the dynamic scene element located in the invisible first scene space unit, to obtain a remaining element part of the dynamic scene element, wherein the remaining scene elements in the scene space comprise the remaining element part of the dynamic scene element.

16. An apparatus for rendering a scene with dynamic object elimination, the apparatus comprising:
at least one memory configured to store program code; and
at least one processor configured to read the program code and operate as instructed by the program code, the program code comprising:
first obtaining code configured to cause the at least one first processor to obtain a first scene space unit in which a dynamic scene element in a scene space is located at a first moment, wherein a first number of scene space units form the scene space;
second obtaining code configured to cause the at least one first processor to obtain a first photographing space unit in which a virtual camera is located in a photographing space at the first moment, wherein the first photographing space unit, wherein a second number of photographing space units form the photographing space;
first determining code configured to cause the at least one first processor to determine a visibility relationship between the first scene space unit and the first photographing space unit based on prestored visibility data, wherein the prestored visibility data comprises visibility relationships between the first number of the scene space units and the second number of the photographing space units;
first removing code configured to cause the at least one first processor to, when the visibility relationship between the first scene space unit and the first photographing space unit is invisible, remove the dynamic scene element from scene elements comprised in the scene space and obtaining remaining dynamic scene elements in the scene space; and
first rendering code configured to cause the at least one first processor to render a scene picture in the first moment by rendering content within an angle of view of a first virtual camera in the scene space based on the remaining dynamic scene elements in the scene space.

17. The apparatus of claim 16, wherein the first obtaining code comprises:
third obtaining code configured to cause the at least one first processor to obtain coordinate information of the dynamic scene element and size information of the dynamic scene element at the first moment;
second determining code configured to cause the at least one first processor to determine a center point of the dynamic scene element based on the coordinate information of the dynamic scene element and the size information of the dynamic scene element; and
third determining code configured to cause the at least one first processor to determine a scene space unit, from the first number of the scene space units, in which the center point of the dynamic scene element is located as the first scene space unit.

18. The apparatus of claim 17, wherein the first obtaining code further comprises:
fourth determining code configured to cause the at least one first processor to determine an offset of the center point of the dynamic scene element relative to a starting point of the scene space at the first moment in at least one spatial dimension;
fourth obtaining code configured to cause the at least one first processor to obtain a quantity of scene units between the starting point and the center point in the at least one spatial dimension by dividing, for each spatial dimension among the at least one spatial dimension, the offset corresponding to the spatial dimension by a size of the scene space unit in the spatial dimension; and
fifth determining code configured to cause the at least one first processor to determine the first scene space unit in which the dynamic scene element is located based on the quantity of scene units between the starting point and the center point in each spatial dimension.

19. The apparatus of claim 16, wherein the prestored visibility data comprises the second number of binary sequences, and each binary sequence is used for indicating first visibility relationships between the first number of the scene space units and a same photographing space unit.

20. A non-transitory computer-readable medium storing program code which, when executed by one or more processors of a device for rendering a scene with dynamic object elimination, cause the one or more processors to at least:
obtain a first scene space unit in which a dynamic scene element in a scene space is located at a first moment, wherein a first number of scene space units form the scene space;
obtain a first photographing space unit in which a virtual camera is located in a photographing space at the first moment, wherein the first photographing space unit, wherein a second number of photographing space units form the photographing space;
determine a visibility relationship between the first scene space unit and the first photographing space unit based on prestored visibility data, wherein the prestored visibility data comprises visibility relationships between the first number of the scene space units and the second number of the photographing space units;
when the visibility relationship between the first scene space unit and the first photographing space unit is invisible, remove the dynamic scene element from scene elements comprised in the scene space and obtaining remaining dynamic scene elements in the scene space; and
render a scene picture in the first moment by rendering content within an angle of view of a first virtual camera in the scene space based on the remaining dynamic scene elements in the scene space.
